(19) United States
(12) Patent Application Publication
(10) Pub. No.: US 2026/0189882 A1
(43) Pub. Date: Jul. 2, 2026

(54) AI DIGITAL AGENT FOR SPORTS COMMUNICATION SYSTEM

(71) Applicant: Digiwrist Technology, Inc., Las Vegas, NV (US)

(72) Inventors: Milton Powell, Buda, TX (US); Gerhard de Beer, Tucson, AZ (US)

(21) Appl. No.: 19/548,342

(22) Filed: Feb. 24, 2026

Related U.S. Application Data
(63) Continuation-in-part of application No. 18/933,760, filed on Oct. 31, 2024.
(60) Provisional application No. 63/762,479, filed on Feb. 24, 2025.

(51) Int. Cl. H04W 4/12; A63B 71/06; A63B 102/18; H04B 1/08

(52) U.S. Cl. CPC H04W 4/12; A63B 71/0622; H04B 1/086; A63B 2071/0663; A63B 2102/18; A63B 2102/182; A63B 2225/50; A63B 2243/007

(57) ABSTRACT

The disclosed invention is directed to a communication system for communication between members of a team during a competition including a wireless computer device in one-way wireless communication with a receiver device worn by a member of a team during the competition, wherein the wireless computer device includes a detachable transmitter module including a microcontroller; memory storage; a modulator; an antenna; and firmware; a power supply; a user interface comprising: a button or switch; a display screen; an artificial intelligence (AI) button; a wireless booster; and a wearable receiving unit.

### RELATED APPLICATIONS

This application is a continuation in part (CIP) of U.S. Non-Provisional application Ser. No. 18/933,760, filed on Oct. 31, 2024, which is herein incorporated by reference in its entirety. This application also claims priority to U.S. Provisional Application No. 63/762,479 filed on Feb. 24, 2025, which is also herein incorporated by reference in its entirety.

### BACKGROUND

There is a need to enhance the participation in sports for the deaf and hard of hearing athletes around the world. Thus, making it feasible for kids with a mental disability like Borderline Intellectual Functioning to understand the complexity of the play calling. Also, to provide a system for kids of all ages to use and easily understand the sports language. Further, to remove sign stealing from sports that utilize hand signals through wireless play calling and shorten game time by increasing the speed of play. Also, for nonverbal commands and communication for government, retail, hospitality, industrial, and aviation field training and professional purposes.

AI (Artificial Intelligence) can be used as a utility to assist coaches with play calling duties. Using digital assistance will help coaches find certain plays already implemented into a digital agent (handheld wireless device or companion) database and at a faster pace. This can shorten the game time by increasing the speed of play. This can also remove sign stealing from sports that utilize hand signals.

### SUMMARY DISCLOSURE OF THE INVENTION

The disclosed invention is directed to a communication system for communication between members of a team during a competition including a wireless computer device in one-way wireless communication with a receiver device worn by a member of a team during the competition, wherein the wireless computer device includes a detachable transmitter module including a microcontroller; memory storage; a modulator; an antenna; and firmware; a power supply; a user interface comprising: a button or switch; a display screen; an artificial intelligence (AI) button; a wireless booster; and a wearable receiving unit.

The disclosed invention implements AI (Artificial Intelligence) as a utility to assist coaches with play calling duties. It provides the ability to request the system in real time which play call options are recommended based on successful plays vs. unsuccessful plays recorded over current and historical time of system use. The tablet can record the pitch and field locations. The more plays that are called and data collected the better the system will be able to assist the coach with game strategy. The inputs used to determine successful plays are as follows: Down and distance, Pass; Run; Gain/Loss; Touchdowns; Defensive Formation; Coverage type; Pitches, Fielding, or defensive shifts. The coach will use manual input OR will take from available data online and/or historic data if team was played in previous games. Using digital assistance will help coaches find certain plays already implemented into the digital agent (handheld wireless computer device or companion) database at a faster pace. Shorten the game time by increasing the speed of play. Remove sign stealing from sports that utilize hand signals through wireless calling. The handheld device has capabilities of calling plays to the wireless receivers worn by the players on the field.

This device will improve training efficiency; it ensures that players receive instructions without needing to leave their positions or halt the flow of the game. It will solve time delays or signal stealing from the opponent. It will allow coaches to quickly adapt their strategies and communicate changes to players in real time. This method will help especially in fast-paced sports where rapid decisions are required. This system will eliminate verbal instructions, confusing hand signals, complex card reading or time-consuming face-to-face interactions. This leads to no more miscommunication, delays or inefficiencies.

This invention is a predictive play calling system that utilizes real-time data processing, artificial intelligence (AI), and wireless communication technology to enhance decision-making for coaches during competitive sporting events. The system comprises a portable computer that will act as a digital agent for the coach and wearable devices worn by players, enabling seamless communication of optimal plays through data-driven predictions.

The disclosed systems and devices will improve training efficiency and ensure that players receive instructions without needing to leave their positions or halt the flow of the game. It solves time delays or signal stealing from the opponent. It allows coaches to quickly adapt their strategies and communicate changes to players in real time. This method helps especially in fast-paced sports where rapid decisions are required. This system eliminates verbal instructions, confusing hand signals, complex card reading or time-consuming face-to-face interactions. This leads to no more miscommunication, delays or inefficiencies.

Other features and aspects will be apparent from the following detailed description, the drawings, and the claims.

### BRIEF DESCRIPTION OF THE DRAWINGS

FIG. 1 shows an exemplary tablet, transmitter, and receiver of the disclosure.

FIG. 2 shows exemplary boosters of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems described herein. However, various changes, modifications, and equivalents of the methods, products, and/or systems described herein will be apparent to an ordinary skilled artisan.

### Modes for Carrying Out the Invention

The present invention relates generally to wearable electronic communication systems and methods, and more particularly to one-way, coach-initiated wireless signaling systems for use during athletic competitions. The invention discloses a one-way Digital handheld wireless communication device designed for transmitting information from a sender to a receiver without enabling feedback. The device will have the capability to send text(s), or voice messages using the Digital agent (handheld wireless device) to the wrist agent(receivers) worn by the player(s) on or off the field. The Data Flow includes a Handheld tablet to the detachable transmitter module (connected by USB cable) which has exterior folding antenna, to the receiver worn by the players (Digiwrist Display/output). The Digital Agent has the capability of using a camera or manual operation to scan QR codes to pair each receiver. The present invention relates to communication devices, specifically to a one-way communication device designed for transmitting information/play calls from a sender using the Digital agent to a wrist agent or companion using the LoRa protocol for long range (field/Stadium safe), low power output, resistant to interference, RF, Wi-Fi, or Bluetooth without feedback or response from the receiver.

### Components

Detachable Transmitter Module: The core component responsible for sending the signal. It includes: Microcontroller: Manages the device's operations. Memory Storage: Stores pre-recorded messages or real-time information to be transmitted. Modulator: Converts the information into a transmittable signal. Antenna: Radiates the signal into the air using Lora. Firmware: Configured to encode command inputs into wireless packets and broadcast said packets.

Power Supply: Provides the necessary power to the transmitter module. It can be a battery or a connection to an external power source.

User Interface: Allows the sender to control the device, which may include: Button or Switch: To start and stop the transmission. Display Screen: To show the status of the transmission (optional). AI (Artificial Intelligence) button: to request, send or text messages to the Digital agent or wrist agent/companion.

Wireless Booster: rechargeable booster worn on the waist of any coach on the sideline for the purpose of blasting the signal again from the transmitter to the receivers worn by the players on the field.

Wearable Receiving Unit: A wireless radio receiver, a power source contained within the housing, a motor for a maximum of 5 vibration to represent different commands, GPS capabilities, at least one output actuator, and a wearable enclosure made for athletic use.

In embodiments, the operation of the device is as follows. (1) Message Preparation: The user records or selects the message to be transmitted, which is stored in the memory of the computer, or complied from using artificial intelligence in real time which can be portable or not. (2) Transmission Activation: The user activates the device using the button or switch on the user interface. (3) Signal Modulation: The microcontroller retrieves the message from the memory and sends it to the modulator. (4) Signal Transmission: The modulated signal is sent to the exterior antenna, and booster which broadcasts it to the receiver(s). (5) Signal Reception: The receivers receive the signal to its antenna awaiting incoming messages. (6) Signal Modulation: The Modulator receives the message and sends it to the microcontroller in the wrist agent. (7) Message Interpretation: The Modulator sends the message to the receiver's micro controller which then interprets the message, vibrates upon reception, and displays it to the player on a display, like an LCD, TFT, or any other display of the like.

(8) Power Management: The device includes a power management system to ensure efficient use of power, turning off the transmitter when not in use to conserve battery life. When a booster is included then the booster will insert between steps 4 and 5 and perform the following steps in this order: 5 (signal reception); 6 (signal modulation); 7 (message interpretation); and then the firmware prepares the signal to be sent for steps 1-4 rather than the user.

The Digital Agent (handheld computer wireless device) uses a utility to relay information to the wrist agent(receivers) worn by the player(s) on and off the field. The coach can ask the digital agent a question using text or voice based on the data that was imputed into the digital agent (wireless handheld device), the digital agent will determine over a series of plays and data identified by the coach as successful plays and will give an estimate of the highest percentage play to call. AI can relay the information to the coach on the interface. The coach will select one of the plays and send it to the wrist agent/companion worn by the player(s) on or off the field of play. A play can be a football play, defensive formation, blitz, etc., or a pitch, or other play action in baseball, including steal, bunt, intentional walk, and so on.

Detachable Transmitter/Dongle from the interface/transmitting computer. Wireless rechargeable Booster worn on the waist of any coach near the field of play for the purpose of blasting the play to the receivers. The wrist agent or receiver can pair to the interface by scanning QR code. The wrist agent or receiver has built in GPS capabilities and LoRa. The wrist agent or receiver has capabilities of maximum 5 motor vibrations for specific and distinguishable commands. For example, 2 vibrations could mean fast ball, or a specific snap count. The wrist agent will go into a deep sleep for power saving mode if no activity within 2 hours of last operation. Wrist agent or receiver is approximately 2.5 to 3 inches long. Digital Agent or tablet sends a text message to the wrist agent worn by the player(s) it will Transmit signal using LoRa (WAN), RF, or in stadium network.

No handshake required for the wrist agent to acknowledge receipt of transmission. LED screens can be installed. Any of the wrist agent(s) can act as a booster to receive and relay the message to other connected devices. Voice to text messages interpretation to transmit to the wrist agent/companions using 6G, LoRa or Radio Frequency. The wrist sleeve is approximately 4.7″ long with 2″ neoprene padding on flap and around edges of receiver for additional protection.

Accelerometer—Enables motion detection and enhances user interaction. Edge Computing—Processes data locally, reducing the need for cloud-based processing and improving response times. Long-Range Communication-Utilizes LoRa and RF 915 MHz for extended communication range, capable of transmitting through in stadium networks. Variations in size of the wrist agent can be plus or minus 2.5 inches long, which snap together. Transmitter connected by USB and/or USBc cable to the computer. Communication protocol, either known or newly designed. Distance of communication using LoRa can be extended, up to 1.5 miles. A variety of cases can be used.

Different methods of activating the transmission can be used like verbally or text. Wrist cloths are custom made to fit only the wrist agent and are specifically padded around the edges and the flap with neoprene padding for impact purposes. The coach interface device may comprise a tablet, or computing device executing software configured to generate discrete command inputs. The interface device communicates with the transmitting units via wired or wireless connection.

Command inputs may correspond to tactical athletic instructions, including but not limited to pitch selection, play selection or situational cues. Wrist receiver has company logo at start up, uses QR code to pair with the tablet, has LED or any of the like, and GPS capabilities for tracking the down and distance. Wrist receiver has deep sleep for saving power. Wrist-mounted wearable device worn beneath athletic cloth apparel. Forearm-mounted wearable device. Team-wide broadcast with player specific filtering. Pattern-based vibration signaling without display or audio. Digital Agent/tablet-keeps game report and can be viewed during the game to be extracted and emailed to others. Play history or game report indicates play called, location of the pitch, player involved, defensive and offensive shifts, date and time of each transaction.

The disclosure includes a sports communication system for communication between members of a team, e.g., players and coaches of a sports team during a sports competition, that includes a wireless computer device in wireless communication with a receiver worn by a team member wherein the wireless computer device comprises: a display, a transmitter module, a microcontroller, a power supply, and an antenna. The receiver worn by the team member includes an antenna, a modulator, a microcontroller, a power supply, and a display, and the wireless communication is one-way communication from the wireless computer device to the receiver that does not even include a handshake (2 way confirmation done automatically) from the receiver to the wireless computer device, and the communication between the wireless computer device and the receiver includes text messaging. The receivers have the ability to manually confirm receipt of the initial commands to and from the tablet.

This disclosed device will improve training efficiency, and ensure that players, staff and trainees receive instructions without needing to leave their positions or halt the flow of a game. It will solve time delays or signal stealing from the opponent. It will allow coaches to quickly adapt their strategies and communicate changes to players in real time. The disclosed systems and methods will help especially in fast-paced sports where rapid decisions are required. This system will eliminate verbal instructions, confusing hand signals, complex card reading or time-consuming face-to-face interactions. This leads to no more miscommunication, delays or inefficiencies.

In embodiments, the invention is directed to one-way communication devices, and methods of using, designed for transmitting information from a sender to a receiver without enabling feedback. The device includes a transmitter module, a repeater, power supply, a detachable dongle with an exterior folding or retractable antenna, and a user interface. It can be used in applications where unidirectional communication is required.

In one embodiment, the system can include a wireless computer device and one or more receivers. The computer may have an interior or exterior detachable dongle with an exterior folding or retractable antenna. The computer can be a tablet computer, notebook or laptop computer, desktop computer, or mobile computing device, or the like. The receiver can be configured to be worn by a player, in a sporting context, or Government, Hospitality, Retail, Industrial, and Aviation industries. The receiver can have a display and may be configured to be worn on the wrist of a user. (player, staff, trainee, professional)

The present invention thus relates to communication devices, e.g., to one-way communication devices designed for transmitting information, for example, play calls in the sports setting from a sender to a receiver without the capability of automatic feedback or response from the receiver of any form, in embodiments, not even a “handshake” back to the interface. With exception of a manual response from the user.

The components include a transmitter module, a microcontroller, memory storage, a modulator, and antenna, a power supply, a user interface, a display screen, and typically a button or switch.

The Transmitter Module is a core component responsible for sending the signal. It includes a microcontroller, memory storage, a modulator, an antenna, power supply, and a user interface which can include a display and a button or switch.

A Microcontroller manages the device's operations. Memory Storage stores pre-recorded messages or real-time information to be transmitted. A Modulator converts the information into a transmittable signal. An antenna radiates the signal into the air. A power supply provides the necessary power to the transmitter module. It can be a battery or a connection to an external power source. A user interface allows the sender to control the device, which may include a button or switch to start and stop a transmission. The display screen can show the status of a transmission.

System operation can include message preparation, transmission activation, signal modulation, signal transmission, signal reception, message interpretation, and power management.

The user records or selects a message to be transmitted, which is stored in the memory of the computer. The message can be a text message. The computer can be a portable laptop or notebook computer, or a desktop, or a mobile device including a smart phone or tablet. The user can activate the device, for example, by using a button or switch on the user interface or by voice activation. The microcontroller retrieves the message from memory and sends it to the modulator. The modulated signal is sent to an antenna, which broadcasts it to the receiver(s).

The receivers receive the signal at an antenna. A Modulator receives the message and sends it to a microcontroller in the receiver. The Modulator sends the message to the receiver's micro controller which then interprets the message, can vibrate upon reception, and displays it to the player on a display, such as a TFT display or the like. In embodiments, the device includes a power management system to ensure efficient use of power, which can turn off the transmitter when not in use to conserve battery life.

In embodiments, the system includes a detachable dongle which is detachable from the interface/transmitting computer, the exterior of which can have an exposed folding or retractable antenna on the casing.

The wrist receiver can pair to the interface using Bluetooth or a QR code. In embodiments, the wrist receiver can be approximately 2.5″ to 3″ long. An associated tablet or computer can send a text message to the wrist receiver worn by a player(s) in a sports context. The signal can be transmitted using RF, Bluetooth, LoRa WAN, or an in-stadium network. In embodiments, no handshake is required for the wrist receiver to acknowledge receipt of transmission. In embodiments, the system does not use cellular or 5G but has the capability of connecting to those networks. The wrist receiver can have an LED screen.

Voice to text message interpretation can be used to transmit to the wrist receivers using LoRa WAN or ISM915 Radio Frequency, or in stadium network. In embodiments, the wrist receiver can include a wrist sleeve which is approximately 4.7″ long with 2″ neoprene padding on a flap and around the edges of the receiver for additional protection. An accelerometer can enable motion detection and enhances user interaction. Edge Computing can be used to process data locally, reducing the need for cloud-based processing and improving response times. Long-Range Communication can utilize both LoRa and RF 915 MHz for extended communication range, capable of transmitting through in stadium networks.

The receiver can be about 2.5 to about 3 inches long and can vary in size from plus or minus about 2.5 inches. The receiver can be of a smartwatch design. Enclosures that house the computer and receiver's electronic components can vary for physical appearance and size. Communication protocols can be either known or specially designed for a particular application. Different methods of activating the transmission can be used such as verbal activation.

Wrist cloths are custom made to fit only the receiver and are specifically padded around the edges and the flap with neoprene padding for impact purposes. PCB can be used for the transmitter and for the receiver.

In embodiments, the disclosure includes sports, and professional communication products and systems which include a wireless computer device and wireless communication with a receiver. More specifically, the wireless communication between the wireless computer device and the receiver is one way communication. The receiver may be worn by a player in the sports competition, preferably, on the wrist of the player. Preferably, the wireless communication includes text messaging. In one specific embodiment, the system can be used to communicate plays from a coach to a player in a sporting match or competition.

In embodiments, the disclosure also includes methods of using a sports communication system, as disclosed herein, in a sporting competition that includes inputting messages into a wireless computer device, transmitting the messages to a receiver worn by a player in a sporting competition, wherein the messages can be text messages, receiving the messages at the receive, and displaying the messages. The receiver receives the messages from the wireless computer device and displays them to the player. The communication can be one-way communication between the wireless computer device and the receiver worn by the player. In a preferred embodiment, the wireless computer device can be operated by a coach, or player not active in the competition, and the receiver can be worn by the player during the competition.

Example tablets of the disclosure can include a homepage, and can be used for football, and baseball/softball.

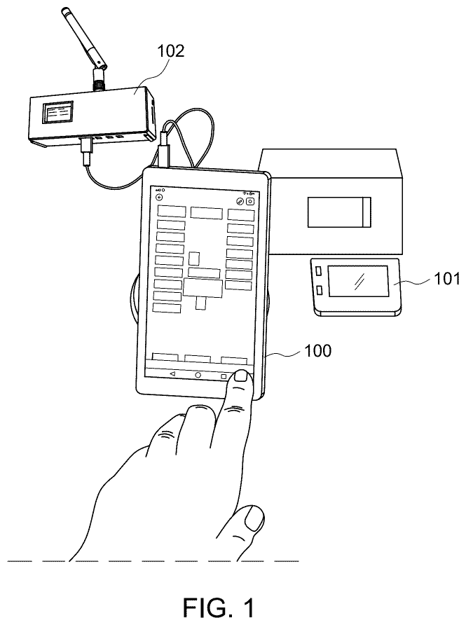

FIG. 1 shows an exemplary tablet 100, transmitter 102 and receiver 101 of the disclosure.

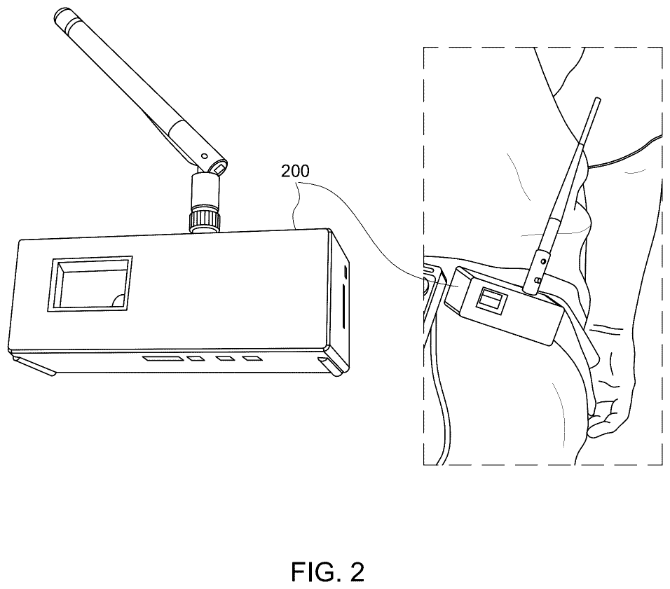

FIG. 2 shows exemplary boosters 200 of the disclosure.

### Predictive AI Play Calling System

In embodiments, the coach uses a digital agent artificial intelligence (AI) to access publicly available game data and user-provided inputs (including team tendencies, player performance metrics, and situational context). An AI engine processes this data and provides high probability success play recommendations for specific game situations. The tablet acts as the control center, transmitting these recommendations wirelessly to player wearables in real time.

### Wearable Communication Device

Players wear a lightweight, shock-resistant wristband with display that visually conveys the selected play. The wristband is equipped with a wireless transceiver, allowing it to receive play signals from the tablet and light up corresponding text and/or images for rapid comprehension. The device is designed to withstand tackles, collisions, and environmental conditions without compromising functionality.

### Real-Time Data Integration and AI Processing

The system leverages available data sources, such as historical game statistics, historical play calls based on situational events. Situational events include Down and distance, Pass; Run; Gain/Loss; Touchdowns; Defensive Formation; Coverage type, Pitches, Fielding, or defensive shifts time remaining, etc., weather conditions, and player performance data, to generate predictive models. The operator can use manual input or can take from available data online and/or historic data if team was played in previous games. The AI model continuously updates its predictions based on real-time inputs, improving accuracy with each iteration. The resulting play suggestions are optimized for the highest probability of success in each unique game scenario.

Predictive Play Calling: Unlike traditional systems that rely solely on coach input, this system provides dynamic, AI-generated play recommendations tailored to real-time game conditions.

Seamless Communication: The tablet-to-wearable connection ensures that plays are transmitted and displayed on player devices instantly.

Shock-resistant Design: The player wristband is designed with durability in mind, ensuring that it remains operational despite heavy physical contact and environmental exposure.

Public Data Utilization: The system's ability to integrate publicly available game data and user input makes it a powerful tool for coaches aiming to outmaneuver opponents.

Plays can be scanned through the camera of the Digital Agent for interpretation to create and evaluate the play.

Plays can be stored in a central data base that can then calculate and propose high probability success rates through the Digital Agent

### The Coach/User Can Send Commands Through Voice or Text Prompts to the Digital Agent

The invention discloses a one-way Digital agent wireless communication device designed for transmitting information from a sender to a receiver without enabling feedback. The device has the capability to send text or voice messages using artificial intelligence from the Digital agent (handheld wireless device) to the wrist agent or companion worn by the player(s) on or off the field. The device includes a transmitter module, a power supply, a detachable dongle with an exterior folding or retractable antenna, and a user interface for operation. The Digital Agent has the capability of using a camera or manual operation to scan QR codes, Jpeg files, written information or PDF file, pictures or downloading information from the internet. The present invention relates to communication devices, specifically to a one-way communication device designed for transmitting information/play calls from a sender using the Digital agent to a wrist agent or companion as protocol using 6G cellular, RF, Wi-Fi, LoRa, or Bluetooth without the capability of feedback or response from the receiver.

In embodiments, a digital agent communication system can include the following components. Transmitter Module: The core component responsible for sending the signal. It includes Microcontroller which Manages the device's operations. Memory Storage which Stores pre-recorded messages or real-time information to be transmitted. Modulator which Converts the information into a transmittable signal. Antenna: Radiates the signal into the air. Power Supply: Provides the necessary power to the transmitter module. It can be a battery or a connection to an external power source. User Interface: Allows the sender to control the device, which may include (but not limited to): connecting wrist agents, filtering stored information, interacting with the interface to select plays, input commands, send play calls, view stored data. Button or Switch: To start and stop the transmission. Display Screen: To show the status of the transmission (optional). AI (Artificial Intelligence) button: to request, send or text messages to the Digital agent and/or wrist agent/companion.

Message Preparation: The user records or selects the message to be transmitted, which is stored in the memory of the computer, or complied from using artificial intelligence in real time which can be portable or not. Transmission Activation: The user activates the device using the button or switch on the user interface. Signal Modulation: The microcontroller retrieves the message from the memory and sends it to the modulator. Signal Transmission: The modulated signal is sent to the exterior antenna, which broadcasts it to the receiver(s). Signal Reception: The receivers receive the signal to its antenna awaiting incoming messages. Signal Modulation: The Modulator receives the message and sends it to the microcontroller in the receiver. Message Interpretation: The Modulator sends the message to the receiver's micro controller which then interprets the message, vibrates upon reception, and displays it to the player on a display, like a E-Ink, TFT display or any of the like.

Power Management: The device includes a power management system to ensure efficient use of power, turning off the transmitter when not in use to conserve battery life.

When a booster is included then the booster will insert between steps 4 and 5 and perform the following steps in this order: 5 (signal reception); 6 (signal modulation); 7 (message interpretation); and then the firmware prepares the signal to be sent for steps 1-4 rather than the user.

Variations in size of the wrist agent—2.5 inches long, which snap together. Enclosures that house the computer and receiver's electronic components differentials for physical appearance and size. Communication protocol, either known or newly designed. Distance of communication using 6G. Various use cases can be used. Component variations based on new technologies designed.

Different methods of activating the transmission such as verbally or text message. Wrist cloths are custom made to fit only the wrist agent and are specifically padded around the edges and the flap with neoprene padding for impact purposes. Internal or external antenna attached to the Digital agent casing. The entirety of the design can be a custom design for the following: Communication protocol. PCB for transmitter attached to the Digital agent. PCB for wrist agent. Enclosures for transmitter. Enclosures for wrist agent. User experience and application. Implementing AI into one-way communication devices significantly enhances their effectiveness, especially in sports settings like baseball, softball, and football. AI can be integrated into the devices in the following ways:

### Real-Time Data-Driven Decision Making

AI can analyze in-game data (pitch velocity, spin rate, player positioning) and suggest optimal strategies to coaches in real time.

Example: The system can recommend pitch calls based on historical pitcher-batter matchups.

### Voice Recognition & Smart Commands

AI-powered voice recognition allows coaches to issue commands hands-free, translating spoken instructions into pre-set messages delivered to players.

Example: A coach says, “Steal sign,” and the system instantly relays a coded message to the player's device.

### Player Performance Monitoring & Feedback

AI tracks player movements and biometrics, providing automatic feedback based on performance trends.

Example: If a pitcher's mechanics are slightly off, the system could alert the coach, who can send a corrective message.

### Adaptive Communication Based on Game Situations

AI tailors messages based on the situation—whether it's late-game pressure, defensive shifts, or optimizing base running.
Example: If a team is down by one in the final inning, AI could suggest aggressive baserunning strategies and send tailored messages to players.

### Predictive Analytics for Game Strategy

AI analyzes past games, weather conditions, and opposing team tendencies to help make proactive coaching decisions.
Example: The system suggests when to make defensive shifts based on a batter's tendencies against similar pitchers.

### Integration With Wearables & Tracking Systems

AI syncs with devices like Yakkertech™, TrackMan™, or Softball Cloud™ to provide real-time updates to coaches, optimizing play calls.
Example: If a hitter struggles against high fastballs, the AI can remind the coach to reinforce that strategy mid-game.

### EXAMPLES

The Digital Agent (handheld wireless device) uses AI (artificial intelligence) as a utility to relay information to the wrist agent worn by the player(s) on and off the field.

The coach asks the digital agent a question using text or voice based on the data that was imputed into the digital agent (wireless handheld device), the digital agent locates the best possible plays using AI and relay the information to the coach on the interface. The coach selects one of the plays and send it to the wrist agent/companion worn by the player(s) on or off the field of play. The AI agent can also call and create plays that the user would like in the moment. For example, high percentage success plays or if the user wants a new play that is not already in the system based on a particular situation.

Detachable Dongle from the interface/transmitting computer. Exterior exposed folding or retractable antenna on the casing of the tablet. The wrist agent/companion can pair to the interface using RF, Cellular, 6G, Bluetooth, or a QR code. Wrist agent/companion is approximately 2.5″ to 3″ long. Digital Agent sends a text message to the wrist agent worn by the player(s). Transmit signal using 6G, RF, Bluetooth, LoRa (WAN), or in stadium network. No “handshake” required for the wrist agent to acknowledge receipt of transmission.

LED screens can be installed. Voice to text messages interpretation to transmit to the wrist agent/companion using 6G, LoRa, or Radio Frequency. The wrist sleeve is approximately 4-5 inches long with 2″ neoprene padding on flap and around edges of receiver for additional protection. Accelerometer-Enables motion detection, impact measurements, and enhances user interaction for data collection and player performance. Edge Computing-Processes data locally, reducing the need for cloud-based processing and improving response times. Long-Range Communication-Utilizes 6G, LoRa and RF 915 MHz for extended communication range, capable of transmitting through in stadium networks.

### GLOSSARY

A wireless computer device of the disclosure generally refers to tablet computers, portable laptop or notebook computers, desktop computers, as well as smart phones. The wireless computer device generally includes a display, a transmitter module, memory, a microcontroller, and an antenna.

A transmitter is an electronic device which produces electromagnetic waves, typically radio waves, with an antenna and with the purpose of signal transmission to a receiver. The transmitter generates a radio frequency alternating current, which is applied to the antenna. When excited by this alternating current, the antenna radiates radio waves. See Transmitter, Wikipedia, the free encyclopedia, of record, herein incorporated by reference.

A repeater is an electronic device that receives a signal and then retransmits it. Repeaters can be used to extend transmissions so that the signal can cover longer distances or be received on the other side of an obstruction. See Repeater, Wikipedia, the free encyclopedia, of record, herein incorporated by reference.

The receiver or receiver device of the disclosure generally refers to a device between about 1 and about 3 inches wide and about 1 and about 3 inches long. The receiver preferably includes a display, an antenna, a modulator, a microcontroller, and a power supply. The receiver can be configured to be worn on the wrist of a player in a sporting competition, game, match, or contest. The receiver can be rectangular or square in shape. The receiver can be of a smartwatch design. The receiver can have a display capable of displaying text messages. The display could be a TFT display or other active-matrix display.

The term “team” generally is used in its normal sense to mean a plurality of persons associated together in work or an activity. Preferably, the activity is a sports activity or sports competition or game. Baseball or softball is a preferred game.

The term “competition” is used in its normal sense and refers to a type of contest between teams or a match or trial between teams. The competition preferably is a sports competition.

The term “sports” generally refers to team sports or athletic competition including baseball, softball, football, hockey, basketball, volleyball, and the like. Any team sporting competition is contemplated. For example, the communication system could generally provide communication between and amongst players and coaches. In a preferred embodiment, the sports communication system can be football, baseball or softball and includes communication between a coach or manager and all participants and non-participants in the field of play. In a preferred embodiment, the communication can be with or between a coach, catcher, or pitcher or other player for the purpose of play calling.

In other embodiments, the receiver may be worn by professional staff, government, or federal trainees.

One-way wireless communication means that the wireless communication between the computer device and the receiver is one way originating from the computer device to the receiver with no possibility of any wireless communication originating from the receiver device to the computer device, i.e., not even a handshake communication.

A handshake is a signal between two computer devices or programs used to authenticate or coordinate the devices. A handshake is normally accomplished before any further communication between the devices can occur. Handshaking can negotiate parameters that are acceptable to computer devices at both ends of a communication, including but not limited to, information transfer rate, coding alphabet, parity, interrupt procedure, and other protocol or hardware features. Accordingly, lack of a return handshake from a receiver device to a transmitter device means that no communication can occur originating from the receiver device to the transmitter device. See Handshake, Wikipedia, the free encyclopedia, of record, herein incorporated by reference.

Text message communication as referred to herein generally refers to composing and sending electronic messages, typically consisting of alphabetic and numeric characters, between two or more users of mobile phones, tablet computers, smartwatches, desktops/laptops, or other types of compatible computer devices. Preferably SMS type text messaging and other forms of text messaging that include displaying text are contemplated. See Text Messaging, Wikipedia, the free encyclopedia, of record, herein incorporated by reference.

A microcontroller as used herein refers to a small computer on a single integrated circuit. A microcontroller generally includes one or more CPUs (processor cores) along with memory and programmable input/output peripherals. See Microcontroller, Wikipedia, the free encyclopedia, of record, herein incorporated by reference.

A dongle or detachable dongle refers to an exterior or interior computer hardware component that can connect to an interior or exterior port to provide it with added functionality, in embodiments, in this case an antenna. See Dongle, Wikipedia, the free encyclopedia, of record, herein incorporated by reference.

Wireless communication generally includes Long Range Wide Area Network (LoRa) and Radio Frequency (RF), including RF 915 MHz for extended communication range, capable of transmitting through, in house or in stadium networks (e.g., a wireless in stadium private network), sports networks, etc., Local Area Networks (LAN), Bluetooth, Wi-Fi, 3G, 4G, 5G, 6G, and the like. See LoRa, Wikipedia, the free encyclopedia, of record, herein incorporated by reference.

A local area network (LAN) is a computer network that interconnects computers within a specific area such as a residence, school, laboratory, university campus or office building. Preferably, the local area network could be an in-stadium network or a sports network. See Local Area Network, Wikipedia, the free encyclopedia, of record, herein incorporated by reference.

While this disclosure includes specific examples, it will be apparent after an understanding of the disclosure of this application has been attained that various changes in form and details may be made in these examples without departing from the spirit and scope of the claims and their equivalents.

1. A communication system for communication between members of a team during a competition comprising:
a wireless computer device in one-way wireless communication with a receiver device worn by a member of a team during the competition, wherein the wireless computer device comprises: a detachable transmitter module comprising: a microcontroller; memory storage; a modulator; an antenna; and firmware;
a power supply;
a user interface comprising: a button or switch; a display screen; an artificial intelligence (AI) button;
a wireless booster; and
a wearable receiving unit.

2. The communication system of claim 1, wherein the AI button provides predictive play calling including football plays, football defensive formations and strategy including blitz, baseball/softball pitches, baseball/softball base stealing, and/or baseball/softball bunt.

3. The communication system of claim 1, wherein the communication between the wireless computer device and the receiver device comprises text messaging.

4. The communication system of claim 1, wherein the receiver is worn on a wrist of the member of the team.

5. The communication system of claim 1, wherein the display is a TFT display.

6. The communication system of claim 1, wherein the receiver device is about 1 inch to about 5 inches long and about 1 inch to about 5 inches wide.

7. The communication device of claim 1, wherein the receiver device is about 2.5 inches to about 3 inches long and about 2.5 inches to about 3 inches wide.

8. The sports communication system of claim 1, wherein the wireless computer device is a tablet computer.

9. The communication system of claim 1, wherein the communication is via Radio Frequency (RF), Bluetooth, 4G, 5G, 6G, or Long-Range Wide Area Network (LoRa WAN).

10. The communication system of claim 1, wherein the wireless computer device is in wireless communication with a Local Area Network.

11. The communication system of claim 1, wherein the competition is football, baseball, or softball.
